(19) United States
(12) Patent Application Publication
(10) Pub. No.: US 2018/0195798 A1
(43) Pub. Date: Jul. 12, 2018

(54) LYOPHILIZER CONTAINER AND METHOD OF USE THEREOF

(71) Applicant: COOK BIOTECH INCORPORATED, WEST LAFAYETTE, IN (US)

(72) Inventors: Michael L. Taylor, West Lafayette, IN (US); Christopher Nelson, Lafayette, IN (US)

(73) Assignee: COOK BIOTECH INCORPORATED, WEST LAFAYETTE, IN (US)

(21) Appl. No.: 15/865,400

(22) Filed: Jan. 9, 2018

Related U.S. Application Data
(60) Provisional application No. 62/444,031, filed on Jan. 9, 2017.

(51) Int. Cl. F26B 5/06; F26B 25/06; B65D 83/00; B65D 41/10; B65D 39/00; B65D 8/00; B65D 1/02

(52) U.S. Cl. CPC F26B 5/06; F26B 25/06; B65D 83/0022; B65D 41/10; C08L 23/06; B65D 11/02; B65D 1/0207; B65D 1/0246; B65D 39/0005

(57) ABSTRACT

The present embodiments generally relate to containers having utility in the lypohilization of fluids to form powers and to methods of using such containers. One embodiment provides a side-ported syringe. Another embodiment provides a two-part container.

### RELATED APPLICATIONS

This application claims the benefit of priority of U.S. Provisional application Ser. No. 62/444,031 filed on Jan. 9, 2017, which application is incorporated by reference herein in its entirety.

### TECHNICAL FIELD

The present invention generally relates to containers having utility in the lypohilization of fluids to form powers and to methods of using such containers. One embodiment provides a side-ported syringe. Another embodiment provides a two-part container.

### BACKGROUND

Lyophilization, or freeze-drying, is a dehydration process typically used to preserve a perishable material or make the material more convenient for transport. Lyophilization works by freezing the material and then reducing the surrounding pressure to allow the frozen water in the material to sublimate directly from the solid phase to the gas phase.

Tray style freeze-dryers allow the product to be frozen in place and perform both primary (unbound water removal) and secondary (bound water removal) freeze-drying, thus producing the driest possible end-product. Tray freeze-dryers can dry products in bulk or in vials or other containers. When drying in vials, the freeze-dryer is typically supplied with a stoppering mechanism that allows a stopper to be pressed into place, sealing the vial before it is exposed to the atmosphere. This is used for long-term storage.

The current state-of-the-art methods for the lyophilization of fluids to form powders are based on the use of a stoppering lyophilizer. Here, the product to be lyophilized is aliquotted into small vials sized to fit between the shelves of a commercially available tray style lyophilizer. The sizing of the vial is critical to the number of shelves available in a unit for processing. Because the vial has a height limitation, the volume of fluid to be lyophilized is limited.

In addition to the size and volume limitations imposed by the traditional vial, application of the final product is also difficult. The user must be able to reconstitute the lyophilized product with a fluid either inside the vial by penetrating or removing the stopper or by emptying the vial into a secondary vessel for reconstitution.

### BRIEF SUMMARY

One aspect of the present invention provides a syringe including a barrel having a distal end and a proximal end and defining a chamber. The distal end comprises a narrowed opening. A movable plunger is positioned within the chamber and extends from the proximal end of the barrel. A side port is positioned on the upper surface of the barrel and provides for fluid communication between the interior of the barrel and the exterior of the barrel. In one embodiment, a flange is present at the proximal end, is flush with the bottom surface of the barrel and extends laterally from the barrel in a manner so as to prevent rotation of the barrel when it is placed on a flat surface.

In another embodiment, a cap is positioned over the narrowed opening to fluid-seal the narrowed opening. In another embodiment, a stopper sized to engage the side port to form a fluid-tight seal is positioned in the side-port. The interior end of the stopper may be flush with the interior surface of the barrel when the stopper fully engages the side port in a fluid-tight seal. In yet another embodiment, a crimped-on cap is positioned on the stopper.

The barrel may be a barrel having a cylindrical cross-section. In another embodiment, the bottom exterior surface of the barrel includes a flattened portion. In yet another embodiment, the plunger includes a removable proximal end portion.

Another aspect of the invention provides a container including a lower portion defining a lower cavity and an upper portion defining an upper cavity. The lower portion includes a threaded rim sized to engage a complementary threaded rim on a first end of the upper portion to provide a fluid-seal. A narrowed opening is present on a second end of the upper portion.

In one embodiment, a stopper sized to engage the narrowed opening and form a fluid-tight seal is positioned in the narrowed opening. A crimped-on cap may be positioned on the stopper.

In another embodiment, the lower portion and upper portion include a plastic material. For example, the plastic material may be polypropylene, polyethylene, polyvinyl chloride or polyester. In certain embodiments, at least one of the upper portion and the lower portion include a transparent or a translucent material.

### BRIEF DESCRIPTION OF THE DRAWINGS

FIG. 1 is an illustration showing a view of one embodiment of a side-ported syringe of the present invention.

FIG. 2 is another illustration showing a view of one embodiment of a side-ported syringe of the present invention.

FIGS. 3(A) and 3(B) are illustrations showing cross-sectional views of two embodiments of a syringe barrel and associated flange of the present invention. FIG. 3(A) shows a syringe barrel having a cylindrical cross-section. FIG. 3(B) shows a syringe barrel having a flattened bottom surface.

FIG. 4 is an illustration showing one embodiment of a two-part container of the present invention.

FIG. 5 is an illustration showing the upper and lower portions of a two-part container of the present invention.

FIG. 6 is another illustration showing the upper and lower portions of a two-part container of the present invention.

FIG. 7 is an illustration showing a cross-sectional view of another embodiment of a two-part container of the present invention.

### DETAILED DESCRIPTION

Unless otherwise defined, all technical and scientific terms used herein have the same meaning as commonly understood by one of ordinary skill in the art to which this invention pertains. In case of conflict, the present document, including definitions, will control. Preferred methods and materials are described below, although methods and materials similar or equivalent to those described herein can be used in the practice or testing of the present invention. The materials, methods, and examples disclosed herein are illustrative only and not intended to be limiting.

One aspect of the present invention provides a container having utility in the lypohilization of fluids to form powers. In one embodiment, the container is a side-ported syringe. Such a syringe allows for the lyophilization of large volumes of materials. For example, the internal capacity of the syringe may be between 10 ml and 500 ml, or 100 ml and 200 ml, or 10 ml and 60 ml, or 10 ml and 25 ml.

The presence of the side-port allows for lyophilization of increased volumes in devices previously limited to smaller volume products. Also, by allowing for larger volumes of material to be lyophilized, the concentrations of source material need not be as high to achieve the same output product volume. Pre-lyophilization concentrating of solutions may not be necessary.

In addition, the syringe allows a user to reconstitute and deliver product with the syringe used in the lyophilization process instead of requiring the transfer of material to a separate syringe after reconstitution and mixing. There is no need to remove the product from the packaging, jeopardizing sterility, to reconstitute the product. Tracking the volume of product delivered is simplified by the use of a more common and comfortable syringe which may easily be marked volumetrically. Furthermore, the inclusion of a Luer connector on many syringes would allow for the use of familiar, off-the-shelf, delivery nozzles and needles.

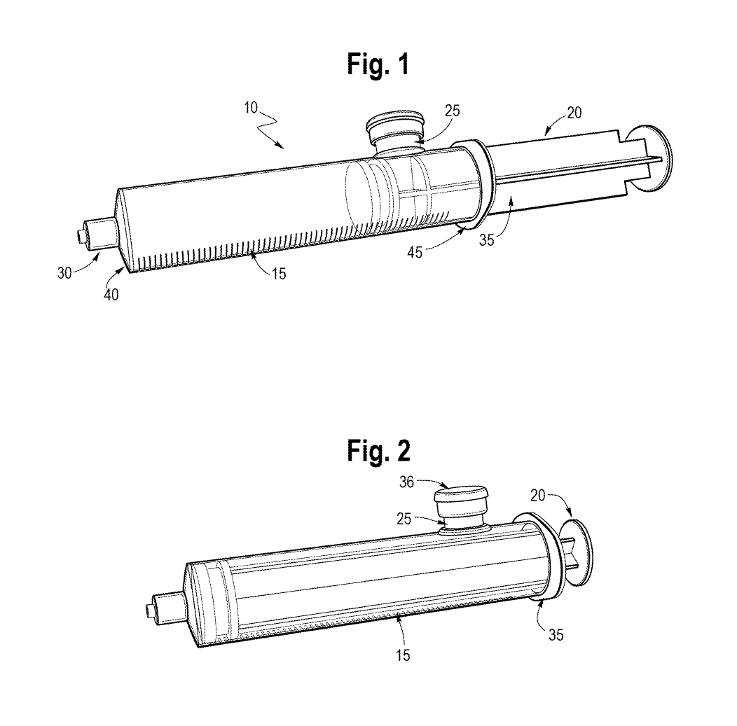

Turning first to FIG. 1, there is here illustrated a side-ported syringe 10 including a barrel 15 having a distal end 40 and a proximal end 45. As used herein, the term “distal” or “distal end” refers to the component or part of a component that is closest to the end of the syringe through which fluid is expelled. The term “proximal” or “proximal end” refers to the component or part of a component that is closest to the opposite end of the syringe.

In this embodiment, distal end 40 includes narrowed opening 30. Narrowed opening 30 may be sealed by a removable cap. In one embodiment, narrowed opening 30 may include a Luer-Lok connection fitting and the removable cap complementary Luer-Lok fitting which screws into it. As will be disclosed in more detail herein, the removable cap may be removed to allow for the contents of barrel 15 to be dispensed from the syringe in a conventional manner.

Plunger 20 is movable within the chamber of barrel 15 and extends from distal end 45. In one embodiment, the plunger may have a removable proximal end portion that may be absent when the syringe is loaded into the lyophilizer. In this embodiment, the distal portion of the plunger is in place at the proximal end of the barrel and seals the proximal end. The proximal portion of the plunger may be added after lyophilization. This embodiment allows for a greater volume of product to be lyophilized at a time as the proximal end of the plunger is not present to occupy space in the lyophilizer. In other embodiments, the plunger is a single unit, for example, as illustrated in FIG. 1.

Turning now to FIG. 2. Side port 25 extends from the upper surface of barrel 15 and provides fluid communication between the interior of the barrel and an exterior of the syringe. Stopper 36 is sized to engage the side port to form a fluid-tight seal. In one embodiment, the end of stopper 36 closest to the interior of barrel 15 is flush with the interior surface of barrel 15 when the stopper engages the side port in a fluid-tight seal. Such a configuration acts to prevent reconstituted product becoming trapped in the interior of the side port when the plunger is moved distally to expel the product from the syringe. A crimped-on cap may be present on the stopper to secure the stopper in position in the side port.

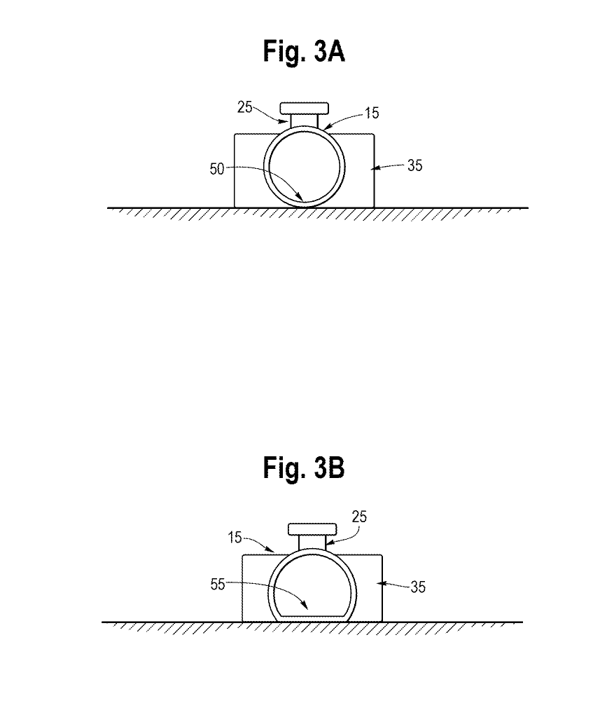

Turning now to FIGS. 3(A) and 3(B). In some embodiments, flange 35 is present at proximal end 45 of the barrel and may provide assistance to the user in moving the plunger inside the barrel of the device. In one embodiment, such as in FIG. 3(A), barrel 15 has a cylindrical cross-section. Here, flange 35 is flush with bottom surface 50 of barrel 15 and extends laterally from barrel 15 to prevent rotation of the barrel when placed on a flat surface. Preventing rotation of the syringe barrel will ensure that the side port and stopper are maintained in the correct orientation during the stoppering step in the lyophilizer. In another embodiment, such as that illustrated in FIG. 3(B), the bottom surface of barrel 15 includes a flattened portion, which can provide for extra stability of the syringe when placed in the lyophilizer and also provide enhanced conductive cooling by increasing surface contact with the lyophilizer shelf.

Another aspect of the invention provides a method of lyophilizing material using a side-ported syringe as disclosed herein. In one embodiment, when filling the syringe with product to be lyophilized, the plunger is fully retracted proximally but remains within the chamber of the syringe. The removable cap is applied to the narrowed end of the syringe barrel. The material to be lyophilized is then added to the syringe through the side port. Once added, the stopper is placed into the side-port in a manner consistent with current practice in conventional lyophilizers. Typically, the stopper will be placed loosely on the side port leaving openings between the side port and the stopper to allow sublimation gasses to escape during the lyophilization procedure.

The filled syringe is then placed into the lyophilizer and the freeze-drying process initiated. At the conclusion of freeze-drying, the stoppering capability of the lyophilizer is employed to depress the stopper fully into the port and seal the barrel of the syringe. The addition of a crimped-on or other cap and any labeling may follow.

To dispense, any cap placed over the stopper is removed. The stopper may be penetrated with a needle or removed to introduce any volume of the reconstitution fluid indicated or desired for the procedure. Once the fluid is added, the stopper can be replaced or re-sealed and the syringe shaken or otherwise to fully reconstitute the lyophilate within the barrel. To dispense the reconstituted product, the discharge (narrowed) end of the syringe is uncapped. The syringe may be oriented such that the discharge end is above that of the plunger end and the plunger advanced to purge any air from the chamber. At this point, the plunger may have been advanced past the site of the side-port with minimal loss of product. For example, the inside end of the stopper may be approximate with the inside wall of the barrel. The device may then be oriented with the discharge end down. Any desired syringe tip or needle may be attached and the product dispensed to the desired location.

Another embodiment of the invention provides ajar having a detachable base and a stoppering-lyophilizer compatible port on the top of the jar. The jar may have any required internal capacity. For example, the internal capacity of the may may be between 10 and 500 ml, or 100 and 200 ml, or 10 and 60 ml. In one embodiment, the internal capacity is such that the height of the jar fits between the shelves of a commercially-available stoppering lyophilizer.

The jar of the present invention allows for an increase in the volume of product that may be lyophilized in a lyophilizer of a given size. Also, by using a jar with a large width to height ratio, the speed of product lyophilization can be increased as the surface area available for sublimation of the product is increased. The jar also allows the user to receive and reconstitute the product in the same vessel. This configuration gives the user visibility to the material while mixing and also provides a more user-friendly mixing environment.

In addition, the user is no longer limited to concentrations of the product that are able to flow from a syringe. This configuration allows for a more viscous product to be mixed and delivered. Also, by allowing larger volumes of material to be lyophilized, the concentration of source material need not be as high to achieve the same output product volume. Pre-lyophilization concentration of solutions may not be necessary.

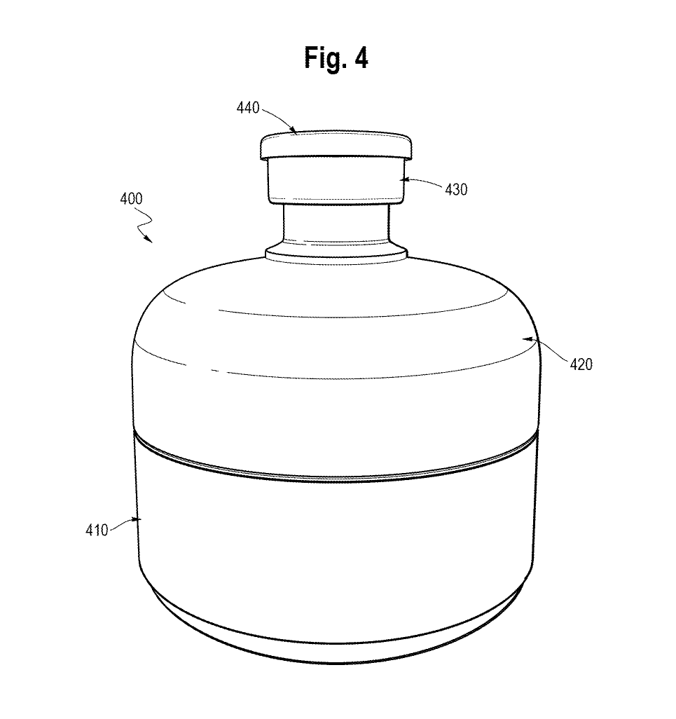

Turning now to FIG. 4, there is here illustrated another embodiment of a container of the present invention. Jar 400 includes lower portion 410 defining a lower cavity and upper portion 420 defining an upper cavity. The top of upper portion 420 includes a narrowed opening, shown here as stoppering-lyophilizer compatible port 430. Stopper 440 is sized to fit into port 430 and form a fluid-tight seal. A crimped-on cap may be positioned on stopper 400. In FIG. 4, the lower portion 410 and upper portion 420 are shown attached to each other to form jar 400 and stopper 440 is shown to be fully inserted into port 430.

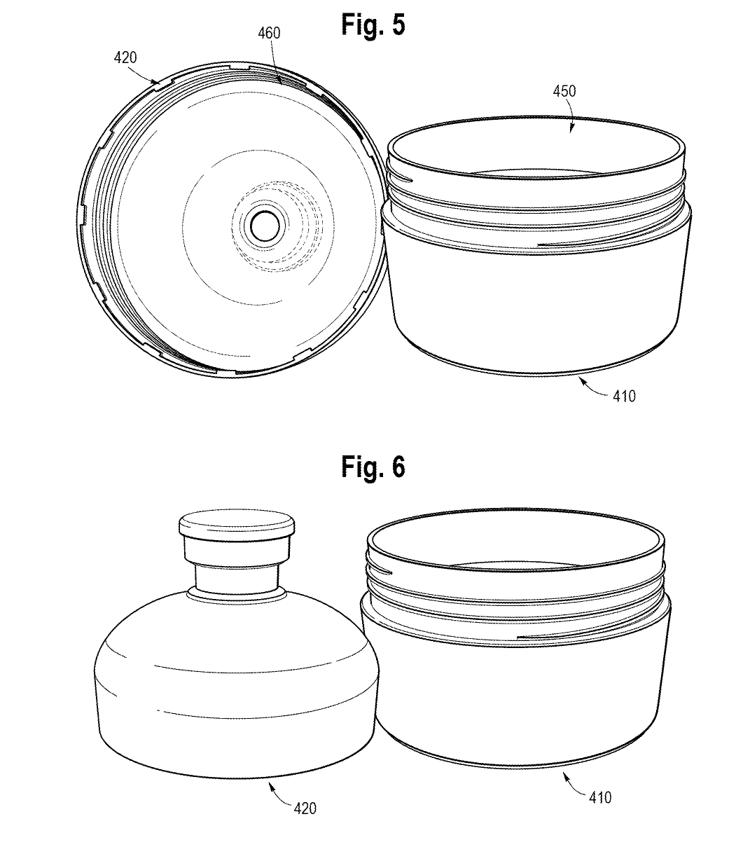

FIGS. 5 and 6 illustrate lower portion 410 and unattached upper portion 420. Lower portion 410 includes threaded rim 450 at its upper end. Threaded rim 450 is sized and shaped to engage complementary threaded rim 460 on the lower end of upper portion 420 so as to provide a fluid-seal.

In one embodiment, lower portion 410 and upper portion 420 are formed from a plastic material. For example, one or both of the two portions may be formed from a material such as polypropylene, polyethylene, polyvinyl chloride or polyester. In some embodiments, at least one of the upper and lower portions is at least partly formed from a transparent or a translucent material.

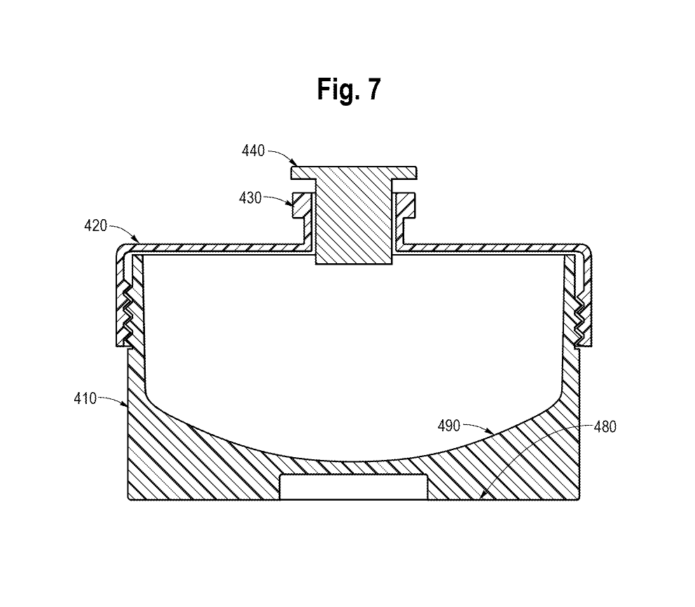

Turning now to FIG. 7, there is here shown a cross-section side view of one embodiment of the jar. Here, lower portion 410 includes a flattened base 480 and a concave lower interior 490. The concave interior may provide for improved reconstitution of the lyophilized product as the danger of product remaining trapped in a corner of the lower portion is reduced. Stopper 440 is illustrated positioned in port 430.

Another aspect of the invention provides a method of lyophilizing and reconstituting a product using a jar as disclosed herein. The upper and lower portions are screwed together to form a fluid-tight seal. The fluid product to be lyophilized is added to the jar through the port at the top of the jar. Once added, the stopper is placed into the port. Typically, the stopper is placed loosely on the top port leaving openings between the port and the stopper to allow sublimation gasses to escape during the lyophilization procedure.

The filled jar is then placed into the lyophilzer and the drying process initiated. At the conclusion of drying, the stoppering capability of the lyophilizer is employed to fully depress the stopper into the port to a seal the container. For example, the port may be compatible with the stoppering mechanism of a device such as the STELLAR® Laboratory Freeze Dryer Series (Millrock Technology, Kingston, N.Y. 12401.) The addition of a crimped-on cap and any labeling may follow.

The lyophilized product may be reconstituted by first detaching (unscrewing) the upper portion of the jar from the lower portion to expose the lyophilized product at the bottom of the lower portion. Any volume of the reconstitution fluid indicated or desired for the procedure is then added. Tools or stirrers may be used to thoroughly mix the lyophilized product and the reconstitution fluid. Following mixing, a syringe may be used to draw the mixture out of the jar, or a spatula-like tool may be used to spread the mixture according to user preference.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

We claim:

1. A syringe comprising,
a barrel having a distal end and a proximal end and defining a chamber, wherein the distal end comprises a narrowed opening;
a plunger movable within the chamber and extending from the proximal end,
a side port positioned on a upper surface of the barrel and providing fluid communication between an interior of the barrel and an exterior of the barrel,
a flange at the proximal end of the barrel, wherein the flange is flush with a bottom surface of the barrel and extends laterally from the barrel to prevent rotation of the barrel when placed on a flat surface.

2. The syringe of claim 1, further comprising a cap positioned over the narrowed opening and sealing the narrowed opening.

3. The syringe of claim 1, further comprising a stopper sized to engage the side port to form a fluid-tight seal.

4. The syringe of claim 1, wherein the stopper comprises an exterior end and an interior end, and wherein the interior end of flush with an interior surface of the barrel when the stopper engages the side port in a fluid-tight seal.

5. The syringe of claim 4, further comprising a crimped-on cap positioned on the stopper.

6. The syringe of claim 1, wherein the barrel is a cylindrical barrel.

7. The syringe of claim 1, wherein bottom surface comprises a flattened portion.

8. The syringe of claim 1, wherein the plunger comprises a removable proximal end portion.

9. The syringe of claim 1, wherein the barrel has a capacity of between 10 ml and 200 ml.

10. A container comprising,
a lower portion defining a lower cavity and an upper portion defining an upper cavity, wherein the lower portion comprises a threaded rim sized to engage a complementary threaded rim on a first end of the upper portion to provide a fluid-seal,
wherein a second end of the upper portion comprises a narrowed opening.

11. The container of claim 10, wherein the lower portion comprises a flattened base and a concave lower interior.

12. The container of claim 10, further comprising a stopper sized to engage the narrowed opening and form a fluid-tight seal.

13. The container of claim 12, wherein the stopper is positioned engaging the narrowed opening and further comprising a crimped-on cap positioned on the stopper.

14. The container of claim 10, wherein the lower portion and upper portion comprise a plastic material.

15. The container of claim 14, wherein the plastic material is selected from the group consisting of polypropylene, polyethylene, polyvinyl chloride and polyester.

16. The container of claim 10, wherein the threaded rim of the lower portion engages the complementary threaded rim of the upper portion and wherein the combined volume of the upper cavity and the lower cavity is between 50 ml and 500 ml.

17. The container of claim 10, wherein the combined volume of the upper cavity and the lower cavity is between 50 ml and 100 ml.

18. The container of claim 10, wherein the lower portion and the upper portion comprise a transparent or a translucent material.

19. A container comprising,
a lower portion defining a lower cavity and an upper portion defining an upper cavity, wherein the lower portion comprises a threaded rim, wherein the upper portion comprises a complementary threaded rim on a first end of the upper portion, wherein the threaded rim and complementary threaded rim engage to provide a fluid-seal, and wherein a second end of the upper portion comprises a narrowed opening;
a stopper engaging the narrowed opening and forming a fluid-tight seal;
and
a crimped-on cap positioned on the stopper;
wherein the lower portion and upper portion comprise a plastic material.
